(19) United States
(12) Patent Application Publication
(10) Pub. No.: US 2023/0001511 A1
(43) Pub. Date: Jan. 5, 2023

(54) METHOD FOR BUTT WELDING AT LEAST TWO METAL SHEETS

(71) Applicant: BAOSTEEL LASERTECHNIK GMBH, Ravensburg (DE)

(72) Inventors: Gerhard ALBER, Berg (DE); Gerhard BRAUCHLE, Wangen (DE); Martin RETZBACH, Berg (DE)

(73) Assignee: BAOSTEEL LASERTECHNIK GMBH, Ravensburg (DE)

(21) Appl. No.: 17/930,102

(22) Filed: Sep. 7, 2022

Related U.S. Application Data
(63) Continuation of application No. PCT/EP2021/056006, filed on Mar. 10, 2021.

(30) Foreign Application Priority Data
Mar. 10, 2020 (DE) 10 2020 106 530.2

(51) Int. Cl. B23K 26/28; B23K 26/38; B23K 37/04; B23K 37/047; B23K 26/242

(52) U.S. Cl. CPC B23K 26/28; B23K 26/38; B23K 37/0435; B23K 37/047; B23K 26/242; B23K 2101/185

(57) ABSTRACT

The present invention relates to a method for butt welding at least two metal sheets, namely a first metal sheet and a second metal sheet, wherein, in particular, a tailored blank is produced from the metal sheets.

### CROSS REFERENCE TO RELATED APPLICATIONS

This application is a continuation of International Application No. PCT/EP2021/056006 filed Mar. 10, 2021, which designated the United States, and claims the benefit under 35 USC § 119(a)-(d) of German Application No. 10 2020 106 530.2 filed Mar. 10, 2020, the entireties of which are incorporated herein by reference.

### FIELD OF THE INVENTION

The present invention relates to a method for the butt-welding of at least two metal sheets.

### DETAILED DESCRIPTION OF THE INVENTION

WO 2008/138973 A1 discloses a method for producing tailored blanks from metal sheets to be butt-joined by welding, wherein at least two combined laser cutting and welding heads, which are borne by at least two independent arms each assigned to independent units of the feed apparatus, are displaced simultaneously along the edges, which are to be produced for the butt joint, of the metal sheets held by a workpiece carrier and trim the edges, and after the metal sheets have been brought together to form the butt joint and the metal sheets have been held by the workpiece carrier, the two combined laser cutting and welding heads are displaced simultaneously along the produced edges, forming the butt joint, of the metal sheets held by the workpiece carrier and produce the weld seam in various, successive portions.

### SUMMARY OF THE INVENTION

It is an object of the present invention to develop a method for the butt-welding of at least two metal sheets, the method ensuring a high quality of the welded connections generated and making it possible to produce tailored blanks with little technical outlay and thus in an efficient manner.

The method according to the present invention for the butt-welding of at least two metal sheets, namely a first metal sheet and a second metal sheet, from which, in particular, a tailored blank is produced, provides
that, in a first method step, the first metal sheet is fixed in a first clamping device and the second metal sheet is fixed in a second clamping device,
that, in a second method step, a first edge to be welded is produced on the first metal sheet by means of laser cutting,
that, in a third method step, a second edge to be welded is produced on the second metal sheet by means of laser cutting,
that the second and the third method step are, in particular, carried out in succession or at the same time,
that, in a fourth method step, the first metal sheet and the second metal sheet are positioned relative to one another for carrying out a joining process for joining,
that, in a fifth method step, the two metal sheets are joined along an abutting region, formed by the two edges, by means of laser welding,
that, in the fourth method step, the first metal sheet and the second metal sheet are positioned relative to one another, in each case while maintaining a preload brought about by the fixing produced in the first method step, either by moving the first clamping device or by moving the second clamping device or by moving the first clamping device and the second clamping device in such a way that the edge to be welded of the first metal sheet and the edge to be welded of the second metal sheet lie opposite one another so as to form a joint.

By maintaining the preload, which both metal sheets have during the laser cutting due to a fixing by means of a fixing apparatus, for the laser welding, the edges to be welded of the two metal sheets retain their geometry in an exact manner, with the result that the edges to be welded fit together in an optimal manner. Correspondingly, the method according to the present invention avoids a situation in which deformation of the metal sheets and thus of the edges occurs after the laser cutting due to a change in the stress state of the metal sheets during the positioning of the metal sheets for the laser welding.

Provision is also made for the second, the third and the fourth method step to be carried out in such a way that, prior to the fifth method step, a groove is formed between the first edge to be welded and the second edge to be welded. This makes it possible to produce a weld seam, generated by the laser welding, in a surface-flush manner, such that undesired protrusion of the weld seam is avoided.

Provision is furthermore made for the groove to be in the form of a V groove or in the form of a Y groove or in the form of an HV groove or in the form of an HY groove. In this way, the selection of the shape of the groove can be adapted to the respective combinations of material and thickness of the metal sheets.

It is also provided that, during the second method step, the first edge to be welded is prepared by means of laser cutting in such a way that, after the laser cutting, an angle >90° is enclosed between the first edge and a top side of the first metal sheet, the top side adjoining the first edge, and that, during the third method step, the second edge to be welded is prepared by means of laser cutting in such a way that, after the laser cutting, an angle > or =90° is enclosed between the second edge and a top side of the second metal sheet, the top side adjoining the second edge. This ensures that a groove with a V-shaped cross section is formed between the metal sheets after the cut edges have been pushed together, the groove serving as a receiving space for the melt volume and thus preventing formation of a protruding weld seam.

It is furthermore provided that, after the fourth method step, the first metal sheet and the second metal sheet are oriented in such a way that a first cut surface generated at the first edge lies in a first plane and a second cut surface generated at the second edge lies in a second plane, wherein the first plane and the second plane intersect when a top side of the first metal sheet and a top side of the second metal sheet lie in a third plane or in a third plane and a fourth plane, which are oriented parallel to one another. In this way, a parallel orientation of the planes in which the edges lie is prevented and a receiving space for the melt volume is provided.

Provision is also made for the second and the third method step to be carried out by means of laser beam cutting or by means of remote laser beam cutting (RLC) and for the fifth method step to be carried out by means of laser beam welding or by means of remote laser beam welding (RLW). In this way, a single remote laser is sufficient for cutting the first metal sheet and the second metal sheet and for welding the two metal sheets to one another. In this way, smaller movement travels are sufficient, since the remote laser can reposition the focal point as required.

Provision is furthermore made for the second and the third and the fifth method step to be carried out using the same laser or using the same remote laser. In this way, the technical outlay for an apparatus for producing tailored blanks is lower than other apparatuses, since only one laser is required.

Provision is also made for a spacing between the remote laser and the edge or edges to be welded of the metal sheets when the second, third and fifth method steps are being carried out to in each case be at least 200 mm and preferably at least 300 mm. In this way, metal sheets with spatially curved portions can also be cut and welded in a more effective manner, since the aforementioned spacing makes it possible to avoid collisions more easily.

Provision is also made for the first metal sheet, in the region of its first edge to be welded, and/or the second metal sheet, in the region of its second edge to be welded, to be treated by laser ablation by means of the remote laser prior to the fifth method step and, in particular, prior to the second and third method step, respectively. This makes it possible to clean the metal sheets without any additional technical outlay, and thus the result of the welding process can be improved since no undesired substances pass into the melt bath.

Furthermore, provision is also made for the metal sheets to be configured in terms of their number and shape in such a way that a tailored blank closed in a ring-shaped manner is produced by the method, wherein the tailored blank closed in a ring-shaped manner is produced, in particular, from at least six metal sheets. In order to produce tailored blanks with more than two weld seams, the method according to the present invention is either implemented multiple times or the individual method steps are effected in parallel with one another, the apparatus for producing tailored blanks is then correspondingly equipped with a multiplicity of remote lasers and a multiplicity of clamping devices.

It is also provided that, in the fourth method step, the second metal sheet is positioned in relation to the first metal sheet either in such a way that, to produce a first variant of the tailored blank, a top side of the first metal sheet and a top side of the second metal sheet are brought into a first common plane and the groove is in this case formed in the direction of the top side of the second metal sheet, or in such a way that, to produce a second variant of the tailored blank, a bottom side of the first metal sheet and a bottom side of the second metal sheet are brought into a second common plane and the groove is in this case formed in the direction of the top side of the second metal sheet. In this way, it is possible, solely by way of a different positioning of the weld seam or a different orientation of the metal sheets, to produce “left” and “right” tailored blanks without a further apparatus for producing tailored blanks being required for this.

Provision is furthermore made for a free volume of the groove to be predetermined in such a way that the free volume is filled by a weld seam, which is generated in the fifth method step, as far as an interface,
wherein the interface in the case of metal sheets whose top sides lie in a common plane is defined by this common plane, and wherein the groove is filled in such a way that a fill volume of the weld seam corresponds to the free volume of the groove, or
wherein the interface in the case of metal sheets whose top sides lie at different levels is in the form of an interface which extends from the top side of the first metal sheet to the top side of the second metal sheet in a concavely curved manner, and wherein the groove is filled in such a way that a fill volume of the weld seam lies above the free volume of the groove.

In this way, tailored blanks which meet the requirements in an optimal manner and which, in particular, also do not require any postprocessing in the region of their weld seam can be produced without additional manufacturing steps.

Provision is also made for a fill volume of the weld seam in the fifth method step to be increased by continuous feeding of a filler wire during the laser welding until the free volume of the groove is reached by the fill volume. In this way, it is possible for tailored blanks with greater free volumes of the groove to also be produced in such a way that the free volume is filled completely up to an upper limit and thus optimal cohesion of the metal sheets is ensured.

Provision is furthermore made for a plurality of metal sheets to be connected to form a ring, wherein, for this purpose, these metal sheets are connected by a number of weld seams which corresponds to a number of the metal sheets. This makes it possible to produce ring-shaped tailored blanks in an efficient manner.

Provision is also made for the first edge to be welded and the second edge to be welded to each have a linear profile, such that a linearly running weld seam is formed by the welding. This makes it possible to produce areal tailored blanks in a simple manner.

Provision is furthermore made for the first edge to be welded and the second edge to be welded to each have a two-dimensional, curved profile, such that a weld seam which runs in a two-dimensional, curved manner is formed by the welding. This makes it possible to produce areal tailored blanks with a two-dimensional profile of the weld seam in a simple manner.

Finally, provision is made for the first edge to be welded and the second edge to be welded to each have a three-dimensionally curved profile, such that a weld seam which runs in a three-dimensionally curved manner is formed by the welding. This makes it possible to produce complex components with a three-dimensional profile of the weld seam in a simple manner. These are also referred to as spatial tailored blanks in the context of the present invention.

In the context of the present invention, a tailored blank is understood to mean an article which has been formed from two metal sheets by laser welding, the metal sheets differing with respect to their material thicknesses and/or with respect to their material and/or with respect to their shape and with respect to their coating.

In the context of the present invention, a metal sheet is understood to mean a metal-sheet-shaped workpiece composed of a weldable material.

In the context of the present invention, butt-welding is understood to mean welding two metal sheets in the region of edges which abut against one another.

In the context of the present invention, an edge to be welded of a metal sheet is understood to mean an edge surface running between a top side and a bottom side of the metal sheet and adjoining a top side of the metal sheet.

In the context of the present invention, a remote laser is understood to mean a laser comprising a scanner system which comprises a combination of rotating facet mirrors or tiltable deflection mirrors which can reflect the laser beam at different locations by way of an adjustability of the angles at which the mirrors are oriented.

### BRIEF DESCRIPTION OF THE DRAWINGS

Further details of the present invention will be described in the drawing by means of schematically illustrated exemplary embodiments.

FIGS. 1A to 1I show a sequence of the method according to the present invention;

FIGS. 2A to 2C show an embodiment variant to the method steps shown in FIGS. 1G to 1I;

FIGS. 3A to 3D show grooves formed between differently cut metal sheets;

FIGS. 4A to 4D show tailored blanks formed from the metal sheets shown in FIGS. 3A to 3D;

FIGS. 5A and 5B show a first and a second metal sheet each with a two-dimensional cut edge running in a curved manner;

FIG. 6A shows a first and a second metal sheet each with a three-dimensional cut edge;

FIG. 6B shows a sectional view of FIG. 6A in accordance with the section profile VIa-VIa;

FIGS. 7A to 7C show a method sequence for producing a first embodiment variant of a tailored blank;

FIGS. 8A to 8C show a method sequence for producing a second embodiment variant of a tailored blank in an efficient manner; and

FIG. 9 shows a plan view of a partially complete ring-shaped tailored blank.

### DETAILED DESCRIPTION OF THE INVENTION

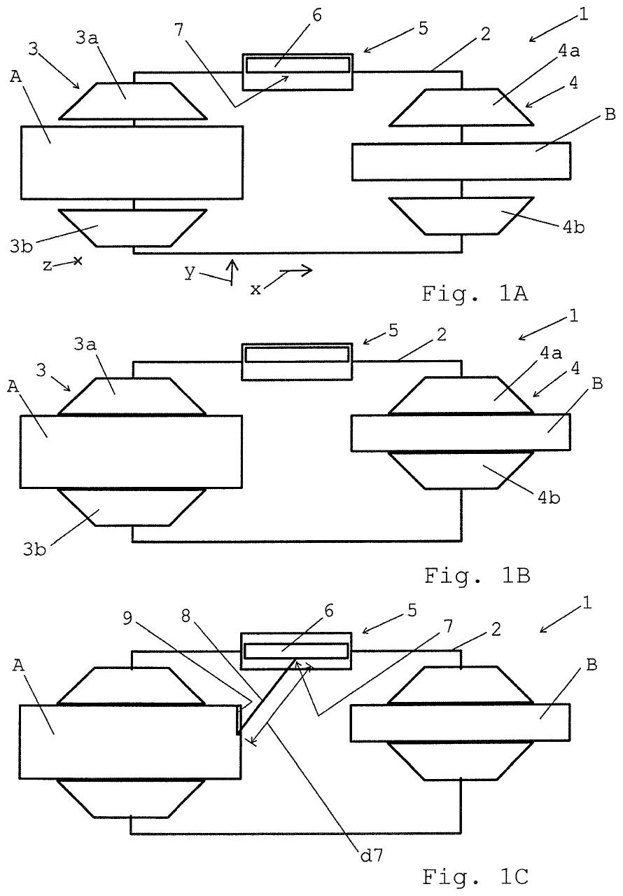

FIGS. 1A to 1I show a sequence of the method according to the present invention by means of schematic illustrations. The method according to the present invention serves for the butt-welding of at least two metal sheets A, B (see, for example, FIG. 1A), namely the first metal sheet A and the second metal sheet B. In the exemplary embodiment, the two metal sheets A, B differ with respect to their material, thus the installation serves for the production of tailored blanks T (see FIGS. 1H and 1I). The method according to the present invention is carried out by means of an apparatus 1 for producing tailored blanks T.

The apparatus 1, which is shown in each of FIGS. 1A to 1H in schematic plan view, comprises a base 2, a first clamping device 3, a second clamping device 4 and a laser device 5. The first clamping device 3 comprises a first clamping jaw 3a and a second clamping jaw 3b. The second clamping device 4 comprises a first clamping jaw 4a and a second clamping jaw 4b. The clamping devices 3, 4 can be displaced independently of one another on the base 2 in two directions x, y in the plane of the drawing. In addition, the displaceability of at least one of the clamping devices 3, 4 perpendicularly with respect to the plane of the drawing in direction z is also provided. Furthermore, the clamping jaws 3a, 3b and 4a, 4b can also be displaced relative to one another. The laser device 5 comprises a head 6 in which a remote laser 7 is received. In this case, the head 6 can be displaced relative to the base 2 in all spatial directions x, y, z. In this case, a laser beam 8 (see FIGS. 1C, 1D and 1G) generated by the remote laser 7 can furthermore be directed by the remote laser 7.

In a first method step, the first metal sheet A is fixed in the first clamping device 3 and the second metal sheet B is fixed in the second clamping device 4 by virtue of the respective clamping jaws 3a, 3b and 4a, 4b being brought together. For this, reference is made to FIGS. 1A and 1B, FIG. 1A showing the two metal sheets A, B in an inserted and still non-clamped state and FIG. 1B showing the metal sheets A, B in a clamped state.

As can be seen from FIG. 1C, in a second method step, a first edge to be welded 9 is produced on the first metal sheet A by means of laser cutting. To this end, the first metal sheet A is cut by the laser beam 8 of the remote laser 7 in such a way that the edge to be welded 9 is formed. In the illustration of FIG. 1C, the laser cut has already been made over almost half the distance.

As can further be seen from FIG. 1D, in a third method step, a second edge to be welded 10 is produced on the second metal sheet B by means of laser cutting. To this end, the first metal sheet B is cut by the laser beam 8 of the remote laser 7 in such a way that the edge to be welded 10 is formed. In the illustration of FIG. 1D, the laser cut has already been made over more than half the distance. During the laser cutting, the head 6 of the laser device 5, and together therewith the remote laser 7, is moved so as to guide the beam, the remote laser 7 likewise being able to direct the laser beam 8.

Provision may also be made for the third step to be carried out prior to the second step.

In the illustration of FIG. 1E, the head 6 of the laser device 5 has been run back into its basic position and the laser beam has been switched off. The edges to be welded 9, 10 of the metal sheets A, B lie at a spacing opposite one another.

In a fourth method step, which is effected between the states shown in FIGS. 1E and 1F, the first metal sheet A and the second metal sheet B are positioned relative to one another for carrying out a joining process such that joining can be effected. To this end, in the exemplary embodiment, the second metal sheet B clamped in the clamping device 4 is moved with the clamping device 4 in the x′ direction and in the y′ direction until the edge 10 thereof bears against the edge 9 so as to form a groove N in an abutting region 11, the groove exclusively having mutually congruent cross sections over the longitudinal extent thereof.

In a fifth method step, the two metal sheets A, B are then joined along the abutting region 11, formed by the two edges 9, 10, by laser welding by means of the remote laser 7. To this end, the laser beam 8 is guided along the abutting region 11 through the groove N. In the illustration of FIG. 1G, a weld seam 12 has already been generated over nearly half the length of the groove N. FIG. 1I then shows the tailored blank T generated from the metal sheets A and B by welding, the weld seam 12 being symbolized by a zigzag line.

It is important that, in the fourth method step, the first metal sheet A and the second metal sheet B are positioned relative to one another, in each case while maintaining preloads brought about by the fixing performed in the first method step by means of the clamping devices, by moving at least one of the clamping devices in such a way that the edge to be welded 9 of the first metal sheet A and the edge to be welded 10 of the second metal sheet B lie opposite one another so as to form a joint 13, which forms the groove N.

The second, the third and the fourth method step are carried out in such a way that, prior to the fifth method step, the groove N is formed between the first edge to be welded 9 and the second edge to be welded 10. To this end, both the first metal sheet A and the second metal sheet B are cut by means of the laser beam 8 in such a way that both the first edge 9 and the second edge 10 are produced in the form of an oblique edge.

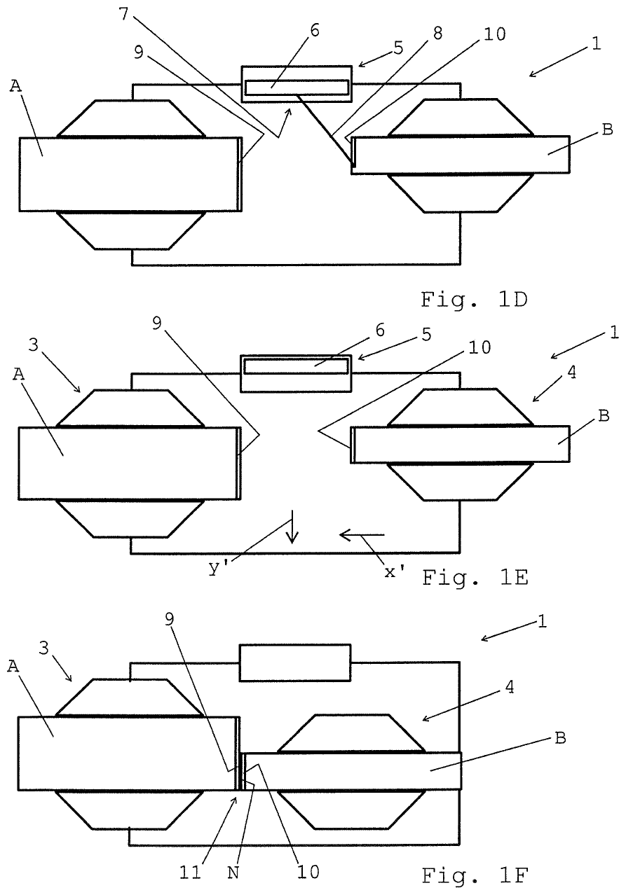

FIGS. 2A to 2C schematically illustrate an embodiment variant to the method explained in relation to FIGS. 1A to 1I. In this case, this embodiment variant comprises the method steps explained in relation to FIGS. 1A to 1F. Correspondingly, reference is made to the above description in this regard. As a deviation from the first variant of the method explained above, the second variant of the method involves welding the first metal sheet A and the second metal sheet B with feed of a filler wire 14, in order to achieve complete filling of the groove N -for example, because the groove N has a greater free volume FV due to a different section profile or due to different thicknesses of the metal sheets A, B—by the laser welding operation. Analogously to FIG. 1I, FIG. 2C then shows the tailored blank 1, removed from the clamping devices 3 and 4 of the apparatus 1, in isolation.

Both in the first method variant and in the second method variant, the one remote laser 7 is used to carry out both the two laser cuts and the welding.

As an alternative, provision is also made for the clamping devices to be in the form of magnetically operating clamping apparatuses or in the form of pneumatically operating clamping apparatuses.

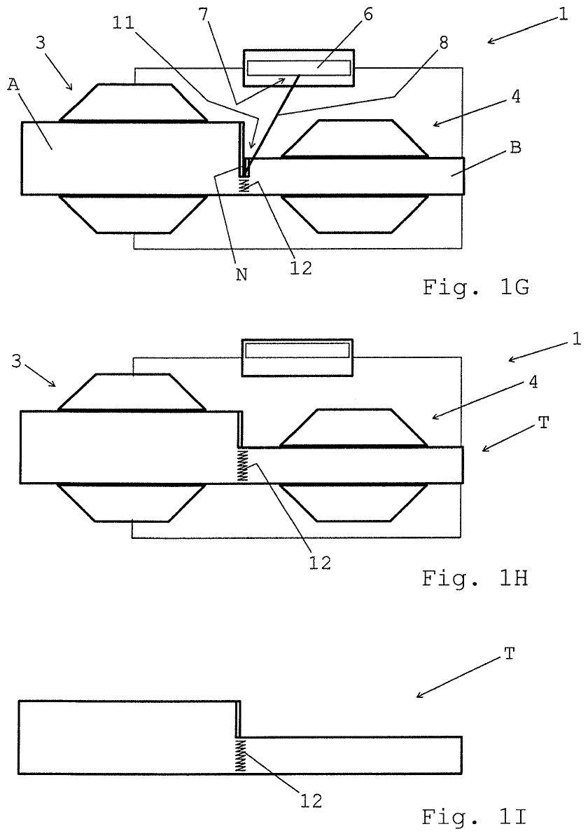

FIGS. 3A to 3D show grooves N1, N2, N3 and N4 between differently cut first metal sheets A1, A2, A3, A4 and second metal sheets B1, B2, B3, B4, between which a joint 13.1, 13.2, 13.3, 13.4 has already been produced. The grooves are produced when, in accordance with one of the method variants described above, the metal sheets A1, B1 or A2, B2 or A3, B3 or A4, B4, respectively, are cut in an oblique manner by means of the remote laser so as to form edges to be welded 9.1, 10.1 or 9.2, 10.2 or 9.3, 10.3 or 9.4, 10.4, respectively, and are subsequently positioned relative to one another so as to form the grooves N1, N2, N3 and N4. In this case, depending on the laser cuts carried out, a V groove N1 (see FIG. 3A) or a Y groove N2 (see FIG. 3B) or an HV groove N3 (see FIG. 3C) or an HY groove N4 (see FIG. 3D) is then formed. The grooves N1 to N4 each have a fill volume FV1, FV2, FV3 and FV4, respectively.

It holds true for all four groove variants N1 to N4 shown in FIGS. 3A to 3D
that, during the second method step, the first edge to be welded 9.1 or 9.2 or 9.3 or 9.4, respectively, is prepared by means of laser cutting in such a way that, after the laser cutting, an angle α1 or α2 or α3 or α4, respectively, >90° is enclosed between the first edge 9.1 or 9.2 or 9.3 or 9.4, respectively, and a top side 15.1 or 15.2 or 15.3 or 15.4, respectively, of the first metal sheet A1 or

A2 or A3 or A4, respectively, the top side adjoining the first edge 9.1 or 9.2 or 9.3 or 9.4, respectively,
in that, during the third method step, the second edge to be welded 10.1 or 10.2 or 10.3 or 10.4, respectively, is prepared by means of laser cutting in such a way that, after the laser cutting, an angle 31 or 32 or 34 or 34, respectively, > or =90° is enclosed between the second edge 10.1 or 10.2 or 10.3 or 10.4, respectively, and a top side 16.1 or 16.2 or 16.3 or 16.4, respectively, of the second metal sheet B1 or B2 or B3 or B4, respectively, the top side adjoining the second edge 10.1 or 10.2 or 10.3 or 10.4, respectively.

Correspondingly, it holds true that, after the fourth method step, the first metal sheet A1, A2, A3, A4 and the second metal sheet B1, B2, B3, B4 are oriented in such a way that a first cut surface 17.1, 17.2, 17.3, 17.4 generated at the first edge 9.1, 9.2, 9.3, 9.4 lies in a first plane E1, E2, E3, E4 and a second cut surface 18.1, 18.2, 18.3, 18.4 generated at the second edge 10.1, 10.2, 10.3, 10.4 lies in a second plane F1, F2, F3, F4, wherein the first plane and the second plane E1, F1, respectively, or E2, F2, respectively, or E3, F3, respectively, or E4, F4, respectively, intersect and thus are not parallel to one another when a top side 15.1, 15.2, 15.3, 15.4 of the first metal sheet A1, A2, A3, A4 and a top side 16.1, 16.2, 16.3, 16.4 of the second metal sheet B1, B2, B3, B4 both lie in a third plane G1, G2, G3 or, as illustrated in FIG. 3D, in a third plane G4 and a fourth plane H4, the planes G4 and H4 being oriented parallel to one another.

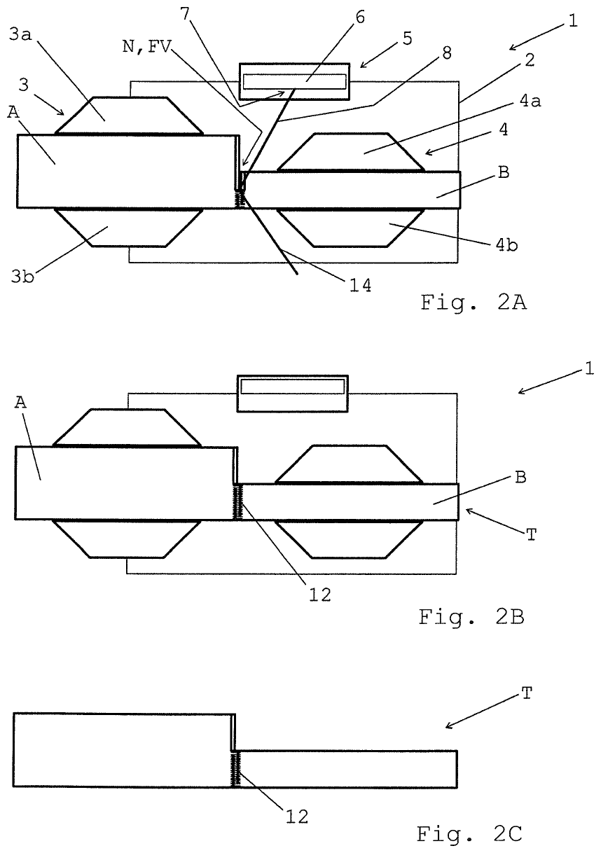

FIGS. 4A to 4D show tailored blanks T1, T2, T3, T4 formed from the metal sheets A1, A2, A3, A4 and B1, B2, B3 and B4, known from FIGS. 3A to 3D, by welding. Weld seams 12.1, 12.2, 12.3 and 12.4 of these tailored blanks T1, T2, T3, T4 are embodied such that they are formed without seam protrusion.

In the variants shown in FIGS. 3A, 4A and 3B, 4B and 3C, 4C, a free volume FV1, FV2, FV3 of the groove N1, N2, N3 is in each case predetermined in such a way that the free volume is filled by the weld seam 12.1, 12.2, 12.3, which is generated in the fifth method step, in each case as far as an interface GF1, GF2 or GF3, respectively. In this case, the interface GF1, GF2, GF3 is defined by the plane G1, G2, G3, and the groove N1, N2, N3 is filled in such a way that a fill volume FV12.1, FV12.2, FV12.3 of the weld seam 12.1, 12.2, 12.3 corresponds to a respective free volume FV1, FV2, FV3 of the groove N1; N2; N3.

In the variant shown in FIGS. 3D and 4D, a free volume FV4 of the groove N4 is predetermined in such a way that the free volume is filled by a weld seam 12.4, which is generated in the fifth method step, as far as an interface GF4. In this case, the interface GF4 is in the form of an interface GF4 which extends from the top side 15.4 of the first metal sheet A4 to the top side 16.4 of the second metal sheet B4 in a concavely curved manner, wherein the groove N4 is filled in such a way that a fill volume FV12.4 of the weld seam 12.4 lies above the free volume FV4 of the groove N4.

As mentioned in relation to FIGS. 1A to 1I and 2A to 2C, the second and the third method step are carried out by means of remote laser beam cutting—with the abbreviation RLC—using the remote laser 7, and the fifth method step is carried out by means of remote laser beam welding—with the abbreviation RLW—using the remote laser 7. Thus, the same remote laser 7 is used three times in the production of the tailored blanks T.

A spacing d7 (see FIG. 1C) between the remote laser 7 and the edge to be welded 9 of the first metal sheet A is in each case at least 200 mm and preferably at least 300 mm, measured in the direction of the laser beam 8. This applies to the execution of the second, third and fifth method step.

In all of the described method variants, provision is optionally also made for the first metal sheet A, in the region of its first edge to be welded 9, and/or the second metal sheet B, in the region of its second edge to be welded 10, to be treated, and thus, in particular, to be cleaned, by laser ablation by means of the remote laser 7 prior to the fifth method step and, in particular, prior to the second and third method step, respectively.

In the case of the metal sheets A, B shown FIGS. 1A to 2C, the edge to be welded 9, 10 has a linear profile, such that the linearly running weld seam 12 is formed by the welding.

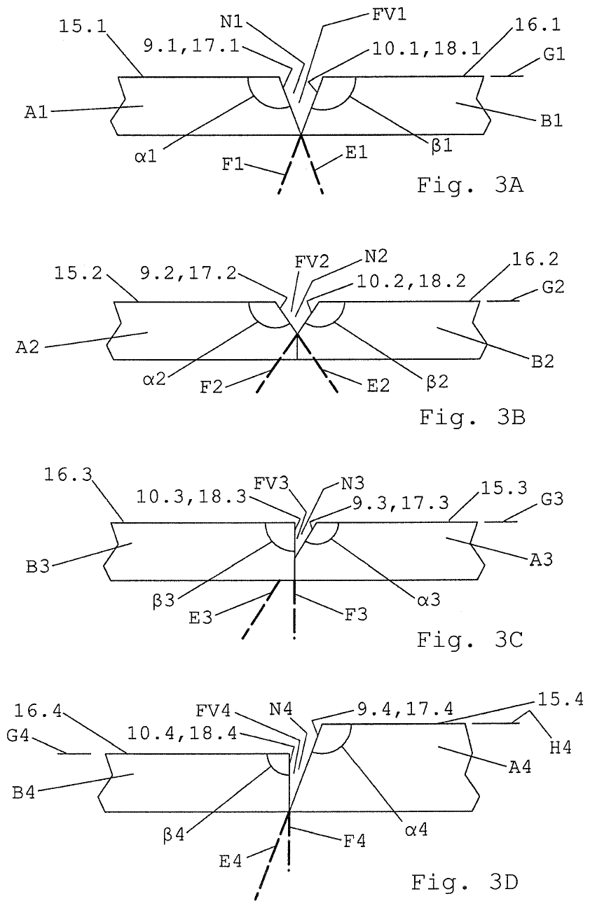

In the case of the metal sheets A5, B5 shown FIGS. 5A to 5B, after the laser cutting, a first edge to be welded 9.5 and a second edge to be welded 10.5 each have a two-dimensional, curved profile, such that a tailored blank T5 with a weld seam 12.5 which runs in a two-dimensional and curved manner is formed by the welding.

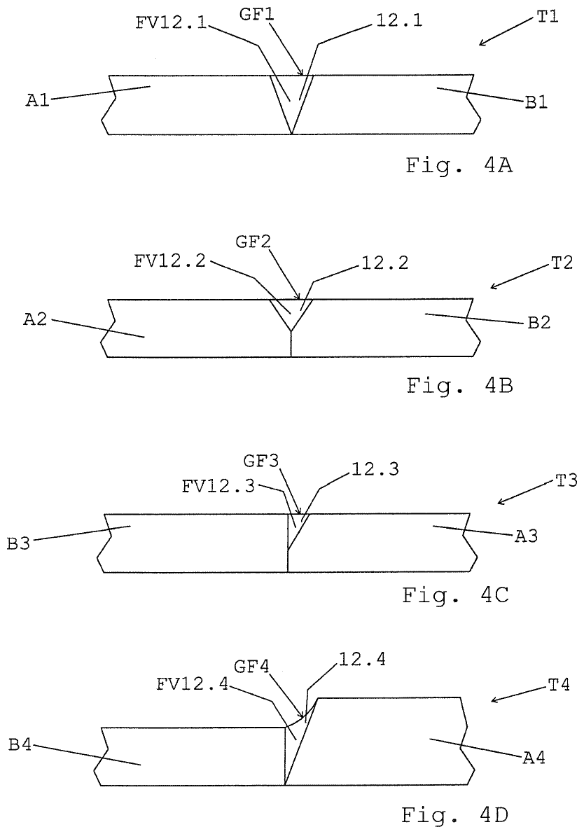

In the case of the metal sheets A6, B6 shown in FIGS. 6A and 6B, a first edge to be welded 9.6 and a second edge to be welded 10.6 each have a three-dimensionally curved profile, such that a weld seam which runs in a three-dimensionally curved manner is formed by the welding. In FIGS. 6A and 6B, the metal sheets A6 and B6 are shown spaced apart from one another. FIG. 6B shows a section through the illustration of FIG. 6A in accordance with the section line VIa-VIa. A component which has a weld seam which runs in a three-dimensionally curved manner is produced from the two metal sheets A6 and B6 by welding. Components of this kind are also referred to as spatial tailored blanks in the context of the present invention.

According to an embodiment variant of the method that is not illustrated, provision is also made for the metal sheets to be configured in terms of their number and shape in such a way that a tailored blank closed in a ring-shaped manner is produced by the method, wherein the tailored blank closed in a ring-shaped manner is produced, in particular, from at least six metal sheets. The apparatus on which this method is carried out then comprises a corresponding number of clamping devices and, where appropriate, a number of laser devices which corresponds to the number of metal sheets. As an alternative, a laser device may also be provided which performs the laser cutting and laser welding of all the metal sheets and which is displaced correspondingly for this purpose, provision also being able to be made that, as an alternative or in addition, the clamping devices are displaced in order to bring the laser device and the metal sheets into position relative to one another. In such a method, to produce a component or tailored blank, a plurality of weld seams are then generated on the component or tailored blank by the same laser device. Such a method reduces the construction outlay for an apparatus for producing such components or tailored blanks considerably.

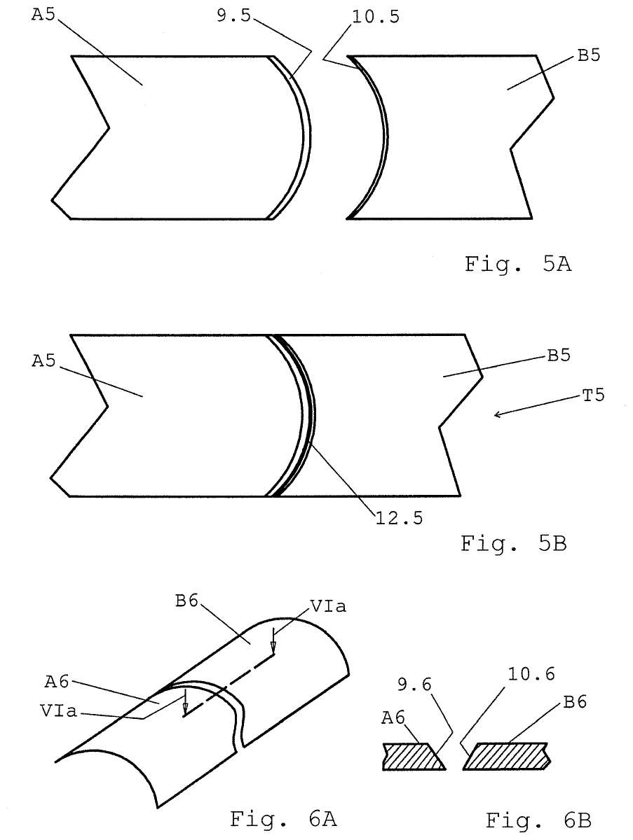

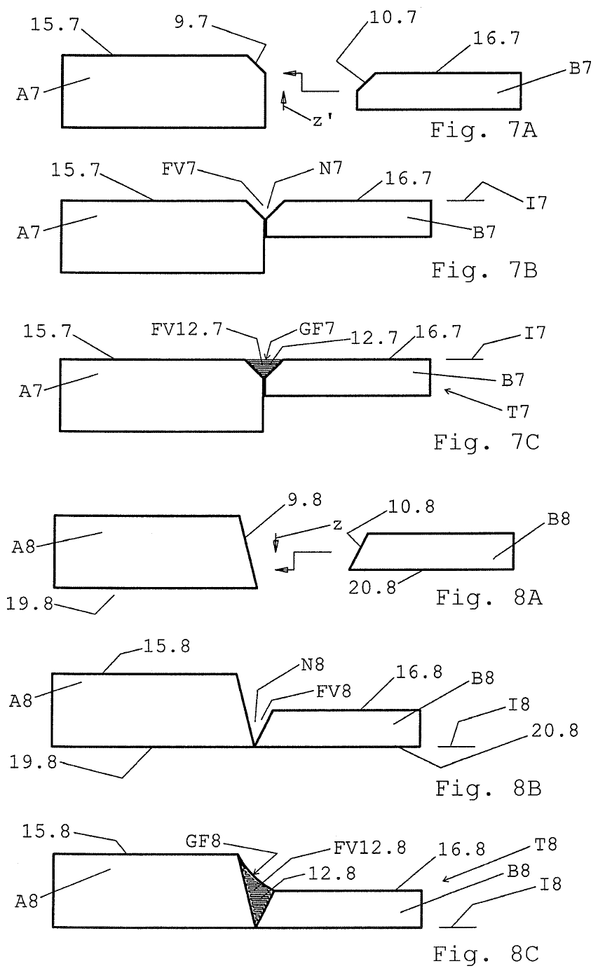

In FIGS. 7A to 8C, method sequences for the efficient production of two embodiment variants of a further tailored blank are described.

To this end, it is provided in the method described in relation to FIGS. 1A to 1I that, in the fourth method step, a second metal sheet B7 or B8, which has a smaller thickness than a first metal sheet A7 or A8, respectively, is positioned in relation to the first metal sheet A7 or A8 either in such a way
that, to produce a first variant of a tailored blank T7 shown in FIG. 7C, a top side 15.7 of the first metal sheet A7 and a top side 16.7 of the second metal sheet B7 are brought into a first common plane 17 after the laser cutting and a groove N7 is in this case formed in the direction of the top side 16.7 of the second metal sheet B7, or in such a way
that, to produce a second variant of a tailored blank T8 shown in FIG. 8C, a bottom side 19.8 of a first metal sheet A8 and a bottom side 20.8 of a second metal sheet B8 are brought into a second common plane 18 and a groove N8 is in this case formed in the direction of a top side 15.8 or 16.8 of the first or the second metal sheet B8, respectively.

In order to position the metal sheets A7, B7 and A8, B8, respectively, relative to one another, at least one of the clamping devices (not illustrated) in which the metal sheets are clamped during all of the laser processing steps is additionally displaced in the above-mentioned third spatial direction z or z′.

In this case, laser cutting of the first metal sheet A7 and of the second metal sheet B7 so as to form edges 9.7 and 10.7 is effected in such a way that a Y seam is formed as weld seam 12.7 between the metal sheets A7, A8 after the laser welding.

In this case, laser cutting of the first metal sheet A8 and of the second metal sheet B8 so as to form edges 9.8 and 10.8 is effected in such a way that a V seam is formed in each case as weld seam 12.8 between the metal sheets A8, B8 after the laser welding.

In principle, it is provided for all embodiment variants of tailored blanks that—as, for example, shown in FIGS. 7C and 8C—a free volume FV7 or FV8 of the groove N7 or N8, respectively, is predetermined in such a way that the free volume is filled by the weld seam 12.7 or 12.8, respectively, which is generated in the fifth method step, as far as an interface, wherein the interface is defined by the top side 16.7 or 16.8 of the thinner metal sheet B7 or B8, respectively, of the metal sheets to be welded A7, B7 and A8, B8, respectively, and wherein the groove N7 or N8 is filled in such a way that a fill volume FV12.7 or FV12.8 of the weld seam 12.7 or 12.8, respectively, corresponds to the free volume FV7 or FV8 of the groove N7 or N8, respectively. Depending on the free volume of the respective groove, the fill volume can be increased as required during the laser welding by use of a filler wire such that the fill volume corresponds to the free volume.

If provision is made of laser welding with filler wire, this is taken into account in the predetermination of the free volume of the groove, and the free volume of the groove is correspondingly dimensioned to be greater. Correspondingly, a fill volume of the weld seam in the fifth method step is increased by continuous feeding of a filler wire during the laser welding until the free volume of the groove is reached by the fill volume.

In principle, provision is made in all of the described method variants for the first clamping device 3 and/or the second clamping device 4 to be oriented relative to one another on the basis of coordinates detected in relation to a first laser cut on the first metal sheet A, A1 to A8 and in relation to a second laser cut on the second metal sheet B, B1 to B8.

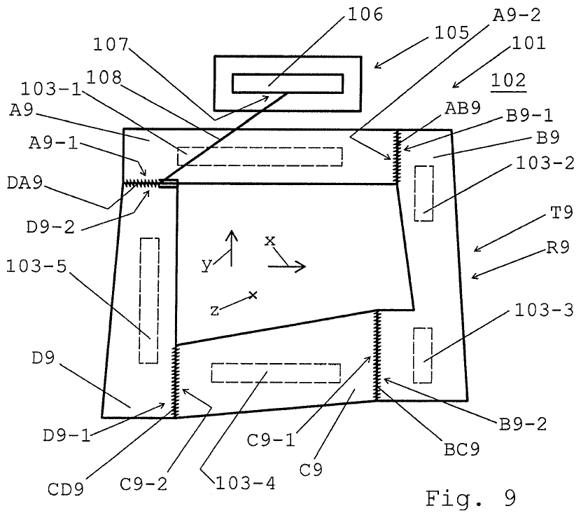

FIG. 9 shows a plan view of a partially complete ring-shaped tailored blank T9. The ring-shaped tailored blank is produced from four metal sheets A9, B9, C9, D9 by butt-welding of these metal sheets A9, B9, C9, D9. The metal sheets A9, B9, C9, D9 differ with respect to their shape and partially with respect to their material. Analogously to the embodiments in relation to FIGS. 1A to 1I, the tailored blank T9 is produced from the four metal sheets A9, B9, C9 and D9 by laser cutting of the metal sheets A9, B9, C9, D9 and laser welding of the metal sheets A9, B9, C9, D9. The method is carried out by means of an apparatus 101 for producing tailored blanks T9.

The apparatus 101 shown in schematic plan view in FIG. 9 comprises a base 102 illustrated by the plane of the drawing, five clamping devices 103-1 to 103-5, and a laser device 105. The clamping devices 103-1 to 103-5 are in the form of magnetic clamping devices. As an alternative, provision is also made for the clamping devices to be in the form of vacuum clamping devices. The clamping devices 103-1 to 103-5 can be displaced independently of one another on the base 102 in two directions x, y in the plane of the drawing. In addition, the displaceability of at least one of the clamping devices 103-1 to 103-5 perpendicularly with respect to the plane of the drawing in direction z is also provided. The laser device 105 comprises a head 106 in which a remote laser 107 is received. In this case, the head 106 can be displaced relative to the base 102 in all spatial directions x, y, z. In this case, a laser beam 108 generated by the remote laser 107 can, furthermore, be directed by the remote laser 107.

In the illustration of FIG. 9, the metal sheets A9, B9, C9, D9 have already been processed by laser cutting. This has generated two edges to be welded A9-1, A9-2, B9-1, B9-2, C9-1, C9-2, D9-1, D9-2 on each of the metal sheets A9, B9, C9, D9. By moving the individual metal sheets A9, B9, C9, D9 by means of the clamping devices 103-1 to 103-5, the metal sheets A9, B9, C9, D9 have been oriented, in succession or at the same time, with their corresponding edges A9-2 and B9-1, B9-2 and C9-1, C9-2 and D9-1, D9-2 and A9-1 against one another, in order to form a ring R9. The pairs of edges A9-2, B9-1 and B9-2, C9-1 and C9-2, D9-1 have already been welded by the remote laser 107, with the result that the metal sheets A9 and B9 are connected by a first weld seam AB9, the metal sheets B9 and C9 are connected by a second weld seam BC9 and the metal sheets C9 and D9 are connected by a third weld seam CD9. In the illustration of FIG. 9, a fourth weld seam DA9 for connecting the pair of edges D9-2, A9-1 is currently being generated by the laser beam 108 of the remote laser 107.

One and the same remote laser 107 is used to carry out both the laser cutting and the laser welding on all of the metal sheets A9, B9, C9 and D9. It goes without saying that this method can also be used to connect more than four metal sheets to form a ring. The apparatus is then equipped with a sufficient number of clamping devices. In the case of larger metal sheets, provision may also be made for the metal sheets to be clamped by means of at least two clamping devices, as is shown in FIG. 9 for the metal sheet B9. Furthermore, provision is also made for a tailored blank closed in a ring-shaped manner to be produced from only two or from only three metal sheets.

Furthermore, provision is in principle also made in the described embodiments, as an alternative, for a conventional laser to be used instead of the remote laser.

### List of Reference Designations

1 Apparatus
2 Base
3 First clamping device
3a, 3b Clamping jaw of 3
4 Second clamping device
4a, 4b Clamping device of 4
5 Laser device
6 Head of 5
7 Remote laser in 6
8 Laser beam
9, 9.1-9.8 Edge to be welded of A
10, 10.1-10.8 Edge to be welded of B
11 Abutting region
12, 12.1-12.5, 12.7,12.8 Weld seam
13, 13.1-13.4 Joint
14 Filler wire
15, 15.1-15.7 Top side of A
16, 16.1-16.8 Top side of B
17.1-17.4 Cut surface on A1-A4
18.1-18.4 Cut surface on B1-B4
19.8 Bottom side of A8
20.8 Bottom side of B8
101 Further apparatus
102 Base
103-1 to 103-5 Clamping device
105 Laser device
106 Head of 5
107 Remote laser in 6
108 Laser beam
A, A1-A9 First metal sheet
B, B1-B9 Second metal sheet
C9 Third metal sheet
D9 Fourth metal sheet
E1-E4 First plane
F1-F4 Second plane
G1-G4 Third plane
H4 Fourth plane
I7 Common plane of 15.7 and 16.7
I8 Common plane of 15.8 and 16.8
N, N1-N8 Groove
R9 Ring
T, T1-T9 Tailored blank
A9-1; A9-2 Edge of A9
B9-1; B9-2 Edge of B9
C9-1, C9-2 Edge of C9
D9-1, D9-2 Edge of D9
AB9, BC9, CD9, DA9 Weld seam
FV1-FV4; FV7, FV8 Free volume of N1-N4, N7, N8
FV12.1-FV12.4 Fill volume of 12.1-12.4
FV12.7, FV12.8 Fill volume of 12.7, 12.8
GF1-GF4, GF7, GF8 Interface
d7 Spacing between 7 and 9 or 10
x, x′, y, y′, z, z′ Spatial direction
α1-α4 Angle between 9.1-9.4 and
15.1-15.4
β1- β4 Angle between 10.1-10.4 and
16.1-16.4

1. A method for the butt-welding of a first metal sheet and a second metal sheet, wherein a tailored blank is produced from these metal sheets,
wherein, in a first method step, the first metal sheet is fixed in a first clamping device and the second metal sheet is fixed in a second clamping device,
wherein, in a second method step, a first edge to be welded is produced on the first metal sheet by laser cutting,
wherein, in a third method step, a second edge to be welded is produced on the second metal sheet by laser cutting,
wherein, in a fourth method step, the first metal sheet and the second metal sheet are positioned relative to one another for carrying out a joining process for joining,
wherein, in a fifth method step, the first and second metal sheets are joined along an abutting region (11), formed by the two edges, by laser welding,
wherein, in the fourth method step, the first metal sheet and the second metal sheet are positioned relative to one another, in each case while maintaining a preload brought about by the fixing produced in the first method step, either by moving the first clamping device or by moving the second clamping device or by moving the first clamping device and the second clamping device in such a way that the edge to be welded of the first metal sheet and the edge to be welded of the second metal sheet lie opposite one another so as to form a joint.

2. The method as claimed in claim 1, wherein the second, the third and the fourth method steps are carried out in such a way that, prior to the fifth method step, a groove is formed between the first edge to be welded and the second edge to be welded.

3. The method as claimed in claim 2, wherein the groove is in the form of a V groove or in the form of a Y groove or in the form of an HV groove or in the form of an HY groove.

4. The method as claimed in claim 1,
wherein, during the second method step, the first edge to be welded is prepared by laser cutting in such a way that, after the laser cutting, an angle a >90° is enclosed between the first edge and a top side of the first metal sheet, said top side adjoining the first edge,
wherein, during the third method step, the second edge to be welded is prepared by laser cutting in such a way that, after the laser cutting, an angle 3 > or =90° is enclosed between the second edge and a top side of the second metal sheet, said top side adjoining the second edge.

5. The method as claimed in claim 1, wherein, after the fourth method step, the first metal sheet and the second metal sheet are oriented in such a way that a first cut surface generated at the first edge lies in a first plane and a second cut surface generated at the second edge lies in a second plane, wherein the first plane and the second plane intersect when a top side of the first metal sheet and a top side of the second metal sheet lie in a third plane or in a third plane and a fourth plane, which are oriented parallel to one another.

6. The method as claimed in claim 1, wherein the second and the third method steps are carried out by laser beam cutting or by remote laser beam cutting, and wherein the fifth method step is carried out by laser beam welding or by remote laser beam welding.

7. The method as claimed in claim 6, wherein the second, the third and the fifth method steps are carried out using the same laser or using the same remote laser.

8. The method as claimed in claim 6, wherein a spacing between the remote laser and the edge or edges to be welded of the first and second metal sheets when the second, third and fifth method steps are being carried out is in each case at least 200 mm.

9. The method as claimed in claim 6, wherein the first metal sheet, in the region of its first edge to be welded, and/or the second metal sheet, in the region of its second edge to be welded, are/is treated by laser ablation by the remote laser prior to the fifth method step and in particular prior to the second and third method step, respectively.

10. The method as claimed in claim 1, wherein the metal sheets are configured in terms of their number and shape in such a way that a tailored blank closed in a ring-shaped manner is produced by the method, wherein the tailored blank closed in a ring-shaped manner is produced from at least four metal sheets.

11. The method as claimed in claim 2, wherein, in the fourth method step, the second metal sheet is positioned in relation to the first metal sheet either in such a way
that, to produce a first variant of the tailored blank, a top side of the first metal sheet and a top side of the second metal sheet are brought into a first common plane and the groove is in this case formed in the direction of the top side of the second metal sheet, or in such a way
that, to produce a second variant of the tailored blank, a bottom side of the first metal sheet and a bottom side of the second metal sheet are brought into a second common plane and the groove is in this case formed in the direction of the top side of the second metal sheet.

12. The method as claimed in claim 2, wherein a free volume of the groove is predetermined in such a way that said free volume is filled by a weld seam, which is generated in the fifth method step, as far as an interface,
wherein the interface in the case of metal sheets whose top sides lie in a common plane is defined by this common plane, and wherein the groove is filled in such a way that a fill volume of the weld seam corresponds to the free volume of the groove, or
wherein the interface in the case of metal sheets whose top sides lie at different levels is in the form of an interface which extends from the top side of the first metal sheet to the top side of the second metal sheet in a concavely curved manner, and wherein the groove is filled in such a way that a fill volume of the weld seam lies above the free volume of the groove.

13. The method as claimed in claim 12, wherein a fill volume of the weld seam in the fifth method step is increased by continuous feeding of a filler wire during the laser welding until the free volume of the groove is reached by the fill volume.

14. The method as claimed in claim 1, wherein a plurality of metal sheets are connected to form a ring, wherein, for this purpose, these metal sheets are connected by a number of weld seams which corresponds to a number of the metal sheets.

15. The method as claimed in claim 1, wherein the first edge to be welded and the second edge to be welded each have a linear profile, such that a linearly running weld seam is formed by the welding.

16. The method as claimed in claim 1, wherein the first edge to be welded and the second edge to be welded each have a two-dimensional, curved profile, such that a weld seam which runs in a two-dimensional, curved manner is formed by the welding.

17. The method as claimed in claim 1, wherein the first edge to be welded and the second edge to be welded each have a three-dimensionally curved profile, such that a weld seam which runs in a three-dimensionally curved manner is formed by the welding.
